(19) United States
(12) Patent Application Publication
(10) Pub. No.: US 2007/0041636 A1
(43) Pub. Date: Feb. 22, 2007

(54) Apparatus and method for image contrast enhancement using RGB value

(75) Inventors: Mi-hyun Yoon, Seoul (KR); Seung-joon Yang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/371,887

(22) Filed: Mar. 10, 2006

(30) Foreign Application Priority Data
Aug. 17, 2005 (KR) 10-2005-0075451

(51) Int. Cl. G06K 9/00

(52) U.S. Cl. 382/169

(57) ABSTRACT

An apparatus and method for image contrast enhancement using an RGB value. The method includes the steps of: determining a 1^{st} and a 2^{nd} mapping function for contrast enhancement in consideration of a mean luminance value per frame; calculating a first mapping function value by sustituting an input RGB value to the 1^{th} mapping function; and calculating an enhanced RGB value by substituting the first mapping function value to the 2^{st} mapping function. Therefore, by using an RGB signal, instead of a luminance signal, for contrast enhancement, the loss of color is prevented. Furthermore, the effect of contrast enforcement can be maximized by adaptively applying mapping functions to the brightness level of an image.

### CROSS-REFERENCE TO RELATED APPLICATIONS

This application claims priority from Korean Patent Application No. 10-2005-75451 filed on Aug. 17, 2005 in the Korean Intellectual Property Office, the entire content of which is incorporated herein by reference.

### BACKGROUND OF THE INVENTION

1. Field of the Invention

The present invention relates in general to an apparatus and method for image contrast enhancement, and more specifically, to an apparatus and method for image contrast enhancement using an RGB value.

2. Description of the Related Art

Generally, picture quality of a video signal can be deteriorated by various factors. One of the well-known factors causing deterioration in picture quality is a low contrast. Examples of contrast correction methods include gamma correction depending on brightness, histogram equalization, etc.

The basic operation of histogram equalization is to transform a given input image on the basis of its histogram, wherein the histogram represents the density of a gray level distribution of an input image.

The histogram of the gray level distribution provides an overall depiction of the appearance of an image. A gray level properly controlled according to a sample distribution of an image enhances the appearance or contrast of the image.

Among the many methods for image contrast enhancement, histogram equalization, which enhances the contrast of a given image according to the sample distribution of the image, is most widely known. Such a method is disclosed in the following documents [1] and [2]:

[1] J. S. Lim, “Two-dimensional Signal and Image Processing,” Prentice Hall, Englewood Cliffs, N.J., 1990, and [2] R. C. Gonzalez and P. Wints, “Digital Image Processing,” Addison-Wesley, Reading, Mass., 1977.

Also, examples of useful applications of the histogram equalization method for medical image processing and radar image processing are disclosed in the following documents [3] and [4]:

[3] J. Zimmerman, S. Pizer, E. Staab, E. Perry, W. McCartney and B. Brenton, “Evaluation of the Effectiveness of Adaptive Histogram Equalization for Contrast Enhancement,” IEEE Tr. on Medical Imaging, pp. 304-312, December 1988, and [4] Y. Li, W. Wang and D. Y. Yu, “Application of Adaptive Histogram Equalization to X-ray Chest Image,” Proc. of the SPIE, pp. 513-514, vol. 2321, 1994.

Therefore, the method of using a histogram of a given image is usually applied to diverse fields, including medical image processing, infrared image processing, radar image processing, etc.

In general, histogram equalization causes the dynamic range of an image to be stretched, and therefore the distribution density of the resultant image is made flat and the contrast of the image is enhanced.

FIG. 1 is a block diagram of an apparatus for image contrast enhancement according to a related art, and FIG. 2 is a diagram for explaining a method for image contrast enhancement according to a related art. As shown in FIG. 1, the apparatus for image contrast enhancement includes a histogram distribution calculator 11, a histogram information calculator 13, a mean calculator 15, a slope calculator 17, a coefficient calculator 19, a filter 21, and a stretching unit 23.

The histogram distribution calculator 11 calculates a histogram distribution for an input luminance signal in predetermined unit, that is, the histogram distribution H(i)C of a previous luminance signal and the histogram distribution H(i)C of a current luminance signal. To this end, the histogram distribution calculator 11 detects the sum of all gray levels and total number of pixels of an input brightness signal, and a maximum level Max and minimum level Min of the input luminance signal.

The histogram information calculator 13 calculates histogram information data Diff_histo, which is a difference between the histogram distribution H(i)C of the current input luminance signal and the histogram distribution H(i)C of the previous input luminance signal, each distribution being calculated by the histogram distribution calculator 11. The histogram information data Diff_histo is inputted to the coefficient calculator 19 (to be described) and used for calculating a coefficient of a screen.

Instead of using all gray levels of the input luminance signal, the histogram calculator 13 may calculate the histogram data Diff_histor by using only the low gray level portion especially in case of black stretching, and only the high gray level portion especially in case of white stretching.

The mean calculator 15 calculates a mean level Mean of the input luminance signal using the sum of all gray levels and total number of pixels of the input luminance signal, that are detected by the histogram distribution calculator 11.

The slope calculator 17 calculates stretching slopes SLB and SLW, respectively, which are linked to the mean level provided by the mean calculator 15. To this end, the slope calculator 17 first calculates black/white stretching points LB and UW, respectively, which are linked to the mean level Mean using the mean level and a predetermined stretching points L and U.

Next, the slope calculator 17 calculates black/white stretching slopes SLB and SLW, respectively, using the minimum level Min and maximum level Max of the input luminance signal detected by the histogram distribution calculator 11.

For instance, in order to obtain the black stretching slope SLB, the slope calculator 17 finds the black stretching point LB linked to the mean level Mean. Then, the slope calculator 17 obtains the black stretching slope SLB using the black stretching point LB and the minimum level Min detected by the histogram calculator 11. A final black stretching slope SLB' with an adjusted slope can be obtained by applying a weight to the black stretching slope SLB.

The coefficient calculator 19 calculates a coefficient of the current input luminance signal to the previous input luminance signal. That is, the coefficient calculator 19 calculates a coefficient Coeff of a screen using the histogram information data Diff_histo provided by the histogram calculator 13.

Here, ‘Total’ indicates the total number of pixels of the input luminance signal in predetermined unit that are processed in the black/white stretching system.

The filter 21 filters the black stretching slope SLB and the white stretching slope SLW correspondingly to the coefficient Coeff, and outputs coefficient-adaptive black stretching slope F_SLB and white stretching slope F_SLW, respectively.

For example, suppose that the coefficient is in the range from 0 to 255. If the median value of the calculated coefficient Coeff is 128, the filter 21 reflects the current black/white stretching slope corresponding to the current screen and the previous black/white stretching slope corresponding to the previous screen at the same ratio.

Moreover, if the calculated coefficient Coeff is small, it means that the ratio of the change in the screen is small. Thus, the filter 21 reflects the previous black/white stretching slope relatively more. On the other hand, if the calculated coefficient Coeff is large, it means that the ratio of the change in the screen is large. Thus, the filter 21 reflects the current black/white stretching slope relatively more.

Therefore, the filter 21 is capable of performing enhanced filtering adaptively to the ratio of change (i.e., coefficient) of the screen. As such, image flickering on the screen caused by black/white stretching can be removed naturally.

The stretching unit 23 stretches the gray level range of the input luminance signal to a hardware range by mapping the coefficient-adaptive filtered black stretching slope F_SLB and white stretching slope F_SLW with the input luminance signal.

According to a related art technique, the black/white stretching slope adaptive to the mean level Mean of the input luminance signal is particularly used to stretch the input luminance signal, thereby enhancing the contrast of the screen.

However, in case of performing a certain luminance process such as the histogram equalization on a luminance signal for the purpose of contrast enhancement, color correction of a color signal should be accompanied according to the luminance change. Otherwise, a pure color signal may be distorted.

In detail, to show a color image a TV or a video system utilizes RGB model which defines Red, Green and Blue, the three primary colors of light. That is, in the RGB model system, RGB signals are transmitted to the TV set or monitor, and an image is reproduced based on those signals.

In the visible spectrum, Red, Green and Blue are mixed at various ratios to produce desired colors. Each color level can be varied from 0 up to 100%.

Each color can be expressed to a total of 256 levels (0-255) in decimal number. This corresponds to ‘00000000-11111111’ in binary number and ‘00-FF’ in hexadecimal. Therefore, a total number of colors that can be expressed by RGB comes to 256×256×256=16,777,216.

Besides the RGB, there is another color expression method using YCbCr. YCbCr is a family of color spaces used in video systems, in which Y is the luminance component and Cb and Cr the chrominance components. Since the human's eyes are more sensitive to brightness than colors, a color processing method using the luminance signal is being widely used. The relation between RGB and YCbCr can be expressed by the following equations.
Y=0.29900R+0.58700G+0.11400B
Cb=−0.16974R−0.33126G+0.50000B
Cr=0.50000R−0.41869G−0.08131B [Equation 1]

As can be seen in the Equation 1, the related art contrast enhancement method increases the contrast by converting a low luminance value into 0 and a high luminance value into 1. Although the related art technique can increase the contrast by changing the luminance component, an intrinsic color component composed of RGB may be lost in the course.

### SUMMARY OF THE INVENTION

It is, therefore, an object of the present invention to provide a method for image contrast enhancement using an RGB value.

To achieve the above objects and advantages, there is provided a method for image contrast enhancement using an RGB value, the method including the steps of: determining a 1^{st} and a 2^{nd} mapping function for contrast enhancement in consideration of a mean luminance value per frame; calculating a first mapping function value by substituting an input RGB value to the 1^{st} mapping function; and calculating an enhanced RGB value by substituting the first mapping function value to the 2^{nd} mapping function.

Preferably, but not necessarily, the 1^{st} and 2^{nd} mapping functions are determined by setting an exponent for each of the 1st and 2nd mapping functions, respectively.

Here, the 1^{st} mapping function is expressed by the following equation:
y=x^{a}
where, x indicates the input RGB value, y indicates the first mapping function value, and α indicates a constant determined adaptively based on the mean luminance value.

The 2^{nd} mapping function is expressed by the following equation:
z=1−(1−y)^{β}
where, y indicates the first mapping function value, z indicates the enhanced RGB value, and β indicates a constant determined adaptively based on the mean luminance value.

In the step for determining the 1^{st} and 2^{nd} mapping functions, if a difference between the mean luminance value of a frame of interest and the mean luminance value of a previous frame does not exceed a predetermined threshold value, 1^{st} and 2^{nd} mapping functions used in the previous frame are determined as the 1^{st} and 2^{nd} mapping functions for the frame of interest.

Also, in the step for determining the 1^{st} and 2^{nd} mapping functions, if a difference between the mean luminance value of a frame of interest and the mean luminance value of a previous frame exceeds a predetermined threshold value, 1^{st} and 2^{nd} mapping functions used in the frame of interest are selected.

In an exemplary embodiment, the exponent of the 1^{st} mapping function and the exponent of the 2^{nd} mapping function are inversely proportional to each other.

Another aspect of the present invention provides an apparatus for image contrast enhancement using an RGB value, the apparatus including: a function determination unit for determining a 1^{st} and a 2^{nd} mapping function for contrast enhancement in consideration of a mean luminance value per frame; a first mapping unit for calculating a first mapping function value by substituting an input RGB value to the 1^{st} mapping function; and a second mapping unit for calculating an enhanced RGB value by substituting the first mapping function value to the 2nd mapping function.

Preferably, but not necessarily, the function determination unit determines an exponent for each of the 1^{st} and 2^{nd} mapping functions, respectively.

Here, the 1^{st} mapping function is expressed by the following equation:
y=x^{a}
where, x indicates the input RGB value, y indicates the first mapping function value, and α indicates a constant determined adaptively based on the mean luminance value.

The 2^{nd} mapping function is expressed by the following equation:
z=1−(1−y)^{β}
where, y indicates the first mapping function value, z indicates the enhanced RGB value, and β indicates a constant determined adaptively based on the mean luminance value.

In an exemplary embodiment, if a difference between the mean luminance value of a frame of interest and the mean luminance value of a previous frame does not exceed a predetermined threshold value, the function determination unit determines 1^{st} and 2^{nd} mapping functions used in the previous frame are determined as the 1^{st} and 2^{nd} mapping functions for the frame of interest.

Also, in an exemplary embodiment, if a difference between the mean luminance value of a frame of interest and the mean luminance value of a previous frame exceeds a predetermined threshold value, the function determination unit determines 1^{st} and 2^{nd} mapping functions used in the frame of interest as the 1^{st} and 2^{nd} mapping functions.

In an exemplary embodiment, the exponent of the 1^{st} mapping function and the exponent of the 2^{nd} mapping function are inversely proportional to each other.

Still another aspect of the present invention provides an image display device equipped with an apparatus for image contrast enhancement, in which the apparatus includes: a function determination unit for determining a 1^{st} and a 2^{nd} mapping function for contrast enhancement in consideration of a mean luminance value per frame; a first mapping unit for calculating a first mapping function value by substituting an input RGB value to the 1^{st} mapping function; and a second mapping unit for calculating an enhanced RGB value by substituting the first mapping function value to the 2^{nd} mapping function.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a schematic block diagram of an apparatus for image contrast enhancement according to a related art;

FIG. 2 is a graph for explaining a method for image contrast enhancement according to a related art;

FIG. 3 is a schematic block diagram of an apparatus for image contrast enhancement according to one embodiment of the present invention;

FIG. 4A is a graph illustrating the feature of a first mapping function according to one embodiment of the present invention;

FIG. 4B is a graph illustrating the feature of a second mapping function according to one embodiment of the present invention; and

FIG. 4C is a graph featuring the combination of mapping functions according to one embodiment of the present invention.

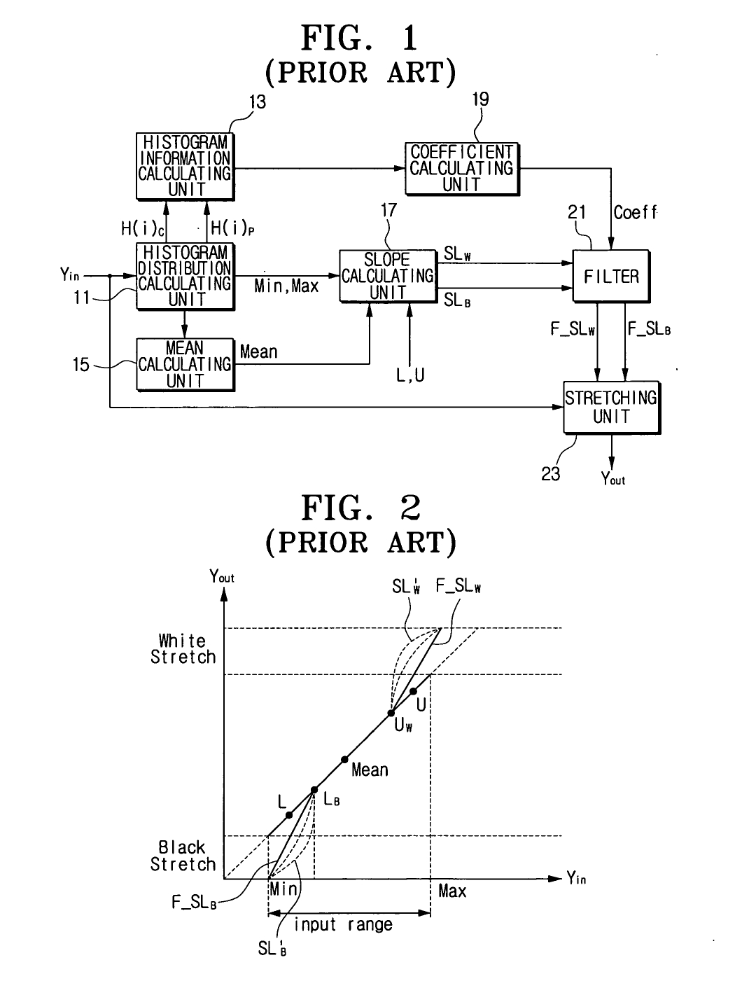

### DETAILED DESCRIPTION OF EXEMPLARY EMBODIMENTS

An exemplary embodiment of the present invention will be described herein below with reference to the accompanying drawings.

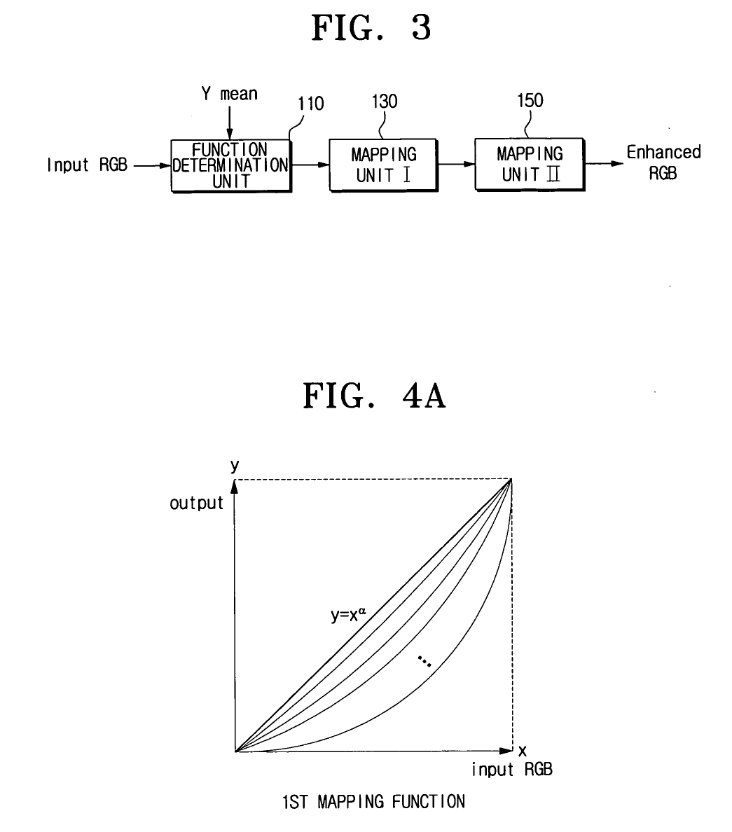

FIG. 3 is a schematic block diagram of an apparatus for image contrast enhancement according to one embodiment of the present invention.

Referring to FIG. 3, the apparatus for image contrast enhancement includes a function determination unit 110, a first mapping unit 130, and a second mapping unit 150. The function determination unit 110 receives an RGB value and transmits it to the first mapping unit 130. Depending on the embodiment, the input RGB value may be input directly to the first mapping unit 130 without going through the function determination unit 110.

The function determination unit 110 determines a 1^{st} mapping function and a 2^{nd} mapping function used in the first mapping unit 130 and the second mapping unit 150, respectively, in consideration of a mean luminance value input to every frame. To be more specific, the function determination unit 110 determines an exponent of the 1^{st} mapping function and of the 2^{nd} mapping function, respectively.

The first mapping unit 130 substitutes the input RGB value from the function determination unit 110 to the first mapping function determined by the function determination unit 110 to yield a first mapping function value, and provides this first mapping function value to the second mapping unit 150.

As aforementioned, the input RGB value can be input directly to the first mapping unit 130 without going through the function determination unit 110.

The second mapping unit 150 substitutes the first mapping function value provided from the first mapping function unit 130 to the second mapping function determined by the function determination unit 110 to yield a final, enhanced RGB value, and outputs this result.

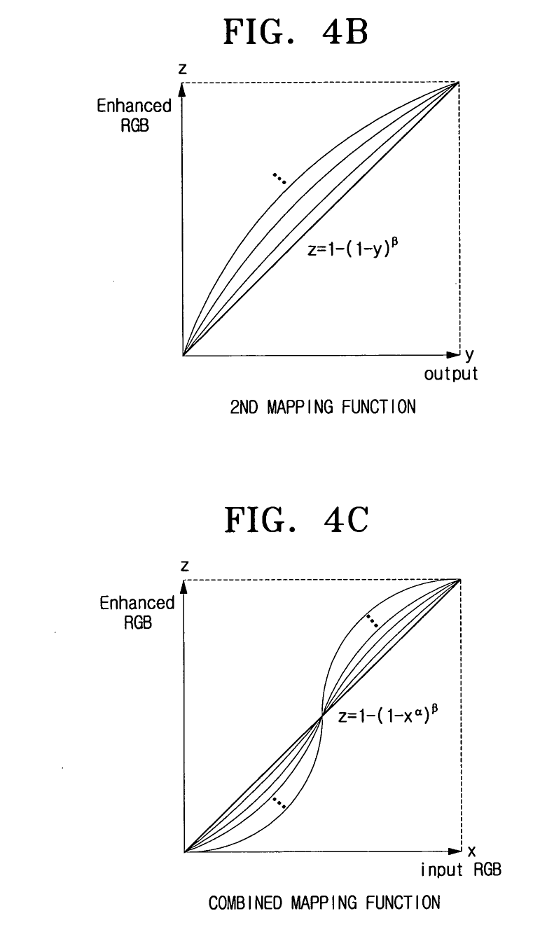

FIG. 4A is a graph illustrating the feature of the 1^{st} mapping function according to one embodiment of the present invention; FIG. 4B is a graph illustrating the feature of the 2^{nd} mapping function according to one embodiment of the present invention; and FIG. 4C is a graph featuring the combination of mapping functions according to one embodiment of the present invention.

First referring to FIG. 4A, the 1^{st} mapping function is a function the first mapping unit 130 uses to calculate a first mapping function value by substituting an input RGB value thereto, and can be expressed by the following equation.
y=x^{α} [Equation 2]
where, x indicates an input RGB value, y indicates a first mapping function value, and α indicates a constant determined adaptively based on the mean luminance value by the function determination unit 110. To see the characteristic of the function, when α=1, y=x, which is a straight line. And, when α value gradually increases greater than 1, the graph shows a curve similar to an exponential graph, getting farther downwardly from the straight line y=x.

Next referring to FIG. 4B, the 2^{nd} mapping function is a function the second mapping unit 150 uses to calculate an enhanced RGB value by substituting the first mapping function value provided from the first mapping unit 130 thereto, and can be expressed by the following equation.
z=1−(1−y)β [Equation 3]
where, y indicates a first mapping function value, z indicates an enhanced RGB value, and β indicates a constant determined adaptively based on the mean luminance value. To see the characteristic of the function, when β=1, z=y, which is a straight line. And, when β value gradually increases greater than 1, the graph shows a curve similar to an exponential graph, getting farther upwardly from the straight line z=y.

Meanwhile, FIG. 4C shows the combination of two functions, the 1^{st} mapping function and the 2^{nd} mapping function, and can be expressed by the following equation.
z=1−(1−x^{α})^{β} Equation 4]
wherein, x indicates an input RGB value, α and β indicate constants determined adaptively by the function determination unit 110, and z indicated an enhanced RGB value. As can be seen in FIG. 4C, the combination of two mapping functions has the shape of an S curve.

In order to get an contrast enhancement effect by stretching the dynamic range of an input RGB value, an input RGB value of a low level should be mapped to an even lower value, and an input RGB value of a high level should be mapped to an even higher value.

In other words, the S-curve mapping function is very useful for contrast enhancement. The reason why the 1^{st} mapping function and the 2^{nd} mapping function are needed to get the S-curve mapping function is that the 1^{st} mapping function is characterized by making an image dark overall, whereas the 2^{nd} mapping function is characterized by making an image bright overall.

Therefore, the S-curve of the combined mapping function can be modified by adjusting the constants (or exponents) α and β in the 1^{st} and 2^{nd} mapping functions. In this manner, contrast can be enhanced adaptively to images.

The following will now explain a method for image contrast enhancement according to one embodiment of the present invention with reference to FIGS. 3, and 4A through 4C.

The function determination unit 110 determines the constant α (exponent of the base x) for the 1^{st} mapping function and the constant β (exponent of the base y) for the 2^{nd} mapping function, in consideration of the mean luminance value per frame.

As shown in the 1^{st} mapping function of FIG. 4A, the shape of the 1^{st} mapping function is determined depending on the constant α (exponent of the base x). That is, as the value of α increases, the graph is curved downwardly from the straight line. Thus, if the value of α is large, a low input value will be outputted as an even lower value through the first mapping function.

Similarly, as shown in the 2^{nd} mapping function of FIG. 4B, the shape of the 2^{nd} mapping function is determined depending on the constant β (exponent of the base y). That is, as the value of β increases, the graph is curved upwardly from the straight line. Thus, if the value of β is large, a high input value will be outputted as an even higher value through the first mapping function.

In short, when both values of α and β are large, a low input value is mapped to even a lower value, whereas a high input value is mapped to even a higher value. As a result, the dynamic range is stretched or broadened and this, in turn, reinforces the contrast enhancement.

Meanwhile, if α>β, the contrast becomes more evident towards dark colors overall, whereas if α<β, the contrast becomes more evident towards bright colors overall.

If the mapping function is applied to every image, dark images will become darker and bright images will become brighter.

Therefore, for implementing the present invention, the function determination unit 110 should determine a constant of each mapping function, according to the mean input luminance level (i.e., the mean brightness).

Generally, brightness of an image with 256 levels is mostly distributed around the median level. Therefore, by applying the 1^{st} and 2^{nd} mapping functions having default constants to the brightness levels greater than the medium brightness level ‘128’, it becomes possible to enhance the contrast of a dark image to be bright, whereas a bright image dark.

The extent of contrast enhancement can be adjusted by controlling the constants α and β in the mapping functions.

For an image with a low level of brightness corresponding to a small mean luminance value, the function determination unit 110 divides the brightness level of such image into many steps. Thus, the lower the level is, the function determination unit 100 gives a small value to the constant α in the 1^{st} mapping function, whereas a large value to the constant β in the 2^{nd} mapping function. In consequence, the overall image becomes bright.

Likewise, for an image with a high level of brightness corresponding to a large mean luminance value, the function determination unit 110 divides the brightness level of such image into many steps. Thus, the higher the level is, the function determination unit 100 gives a high value to the constant α in the 1^{st} mapping function, whereas a small value to the constant β in the 2^{nd} mapping function. In consequence, the overall image becomes dark.

Accordingly, the function determination unit 110 determines the 1^{st} mapping function and the 2^{nd} mapping function for use in the first mapping unit 130 and the second mapping unit 150, in consideration of the input mean luminance value. Then, the first mapping unit 130 substitutes the input RGB value to the 1^{st} mapping function and outputs the first mapping function value. And, the second mapping unit 150 substitutes the first mapping function value to the 2^{nd} mapping function and outputs the enhanced RGB value. This RGB value is input and output for each of the R, G and B values.

However, if the 1^{st} and 2^{nd} mapping functions are always determined by input mean luminance values and applied to image frames accordingly, the mapping functions might be applied differently even when the mean luminance values of consecutive scenes are slightly different from each other. That is, because the extent of contrast enhancement is different even in consecutive scenes, the flickering may occur around the edges of the screen.

To prevent the image flickering, the function determination unit 100 of the present invention calculates a difference between the mean luminance value of the current frame and the mean luminance value of the previous frame, and if the difference exceeds a predetermined threshold value, it judges that the current frame and the previous frame are not of the consecutive scenes. Therefore, the function determination unit 100 determines the 1^{st} and 2^{nd} mapping functions with respect to the mean luminance value of the current frame.

On the contrary, if the difference is not greater than the predetermined threshold value, the function determination unit 110 judges that the previous frame and the current frame are of the same image. Thus, it may use the 1^{st} and 2^{nd} mapping functions determined for the previous frame as the 1^{st} and 2^{nd} mapping functions for the current frame.

As explained so far, the present invention uses an RGB signal, not a luminance signal, for contrast enhancement and thereby prevents the loss of color. Furthermore, the present invention can maximize the effect of contrast enforcement by adaptively applying mapping functions to the brightness level of an image.

Although the exemplary embodiment of the present invention has been described, it will be understood by those skilled in the art that the present invention should not be limited to the described embodiment, but various changes and modifications can be made within the spirit and scope of the present invention as defined by the appended claims.

What is claimed is:

1. A method for image contrast enhancement using an RGB value, the method comprising:
determining a first and a second mapping function for contrast enhancement by taking account of a mean luminance value per frame;
calculating a first mapping function value by substituting an input RGB value to the first mapping function; and
calculating an enhanced RGB value by substituting the first mapping function value to the second mapping function.

2. The method of claim 1, wherein the first and second mapping functions are determined by setting an exponent for each of the first and second mapping functions, respectively.

3. The method of claim 1, wherein the first mapping function is expressed by the following equation:
y=x^{α}
where x indicates the input RGB value, y indicates the first mapping function value, and α indicates a constant determined adaptively based on the mean luminance value.

4. The method of claim 1, wherein the second mapping function is expressed by the following equation:
z=1−(1−y)^{β}
where y indicates the first mapping function value, z indicates the enhanced RGB value, and β indicates a constant determined adaptively based on the mean luminance value.

5. The method of claim 1, wherein, in determining the first and second mapping functions, if a difference between the mean luminance value of a frame of interest and the mean luminance value of a previous frame does not exceed a predetermined threshold value, first and second mapping functions used in the previous frame are determined as first and second mapping functions for the frame of interest.

6. The method of claim 1, wherein, in determining the first and second mapping functions, if a difference between the mean luminance value of a frame of interest and the mean luminance value of a previous frame exceeds a predetermined threshold value, first and second mapping functions used in the frame of interest are selected.

7. The method of claim 2, wherein the exponent of the first mapping function and the exponent of the second mapping function are inversely proportional to each other.

8. An apparatus for image contrast enhancement using an RGB value, the apparatus comprising:
a function determination unit which determines a first and a second mapping function for contrast enhancement by taking account of a mean luminance value per frame;
a first mapping unit which calculates a first mapping function value by substituting an input RGB value to the first mapping function; and
a second mapping unit which calculates an enhanced RGB value by substituting the first mapping function value to the second mapping function.

9. The apparatus of claim 8, wherein the function determination unit determines an exponent for each of the first and second mapping functions, respectively.

10. The apparatus of claim 8, wherein the first mapping function is expressed by the following equation:
y=x^{α}
where x indicates the input RGB value, y indicates the first mapping function value, and α indicates a constant determined adaptively based on the mean luminance value.

11. The apparatus of claim 8, wherein the second mapping function is expressed by the following equation:
z=1−(1−y)^{β}
where y indicates the first mapping function value, z indicates the enhanced RGB value, and β indicates a constant determined adaptively based on the mean luminance value.

12. The apparatus of claim 8, wherein, if a difference between the mean luminance value of a frame of interest and the mean luminance value of a previous frame does not exceed a predetermined threshold value, the function determination unit determines first and second mapping functions used in the previous frame as first and second mapping functions for the frame of interest.

13. The apparatus of claim 8, wherein, if a difference between the mean luminance value of a frame of interest and the mean luminance value of a previous frame exceeds a predetermined threshold value, the function determination unit determines first and second mapping functions used in the frame of interest as the first and second mapping functions.

14. The apparatus of claim 14, wherein the exponent of the first mapping function and the exponent of the second mapping function are inversely proportional to each other.

15. An image display device equipped with an apparatus for image contrast enhancement, in which the apparatus comprises:
a function determination unit for determining a first and a second mapping function for contrast enhancement in consideration of a mean luminance value per frame;
a first mapping unit for calculating a first mapping function value by substituting an input RGB value to the first mapping function; and
a second mapping unit for calculating an enhanced RGB value by substituting the first mapping function value to the second mapping function.
